(19) United States
(12) Patent Application Publication
(10) Pub. No.: US 2026/0093536 A1
(43) Pub. Date: Apr. 2, 2026

(54) ADVANCED DATA-DRIVEN SERVICE EVOLUTION ECOSYSTEM

(71) Applicant: Kyndryl, Inc., New York, NY (US)

(72) Inventors: Reagan Mitchell, Austin, TX (US); Glincy Mary Jacob, Kerala (IN); Omar Odibat, Cedar Park, TX (US); Umar Mohamed loyoob Umar, Manor, TX (US); Simerpreet Singh Sahani, Dublin, CA (US)

(21) Appl. No.: 18/901,068

(22) Filed: Sep. 30, 2024

(51) Int. Cl. G06F 9/50

(52) U.S. Cl. CPC G06F 9/5027

(57) ABSTRACT

A computer-implemented method that receives first data inputs related to an entity and determines at least one service to sunset from a list of services related to the entity, based on the first data inputs. In embodiments the method may further generate recommendations comprising ranked services to add to the list of services related to the entity and determine at least one new competency as a candidate for upgrading at the entity, each based on the first data inputs. The method may further predict an overall impact to the entity based on sunsetting the at least one service, adding at least one service of the ranked services, and/or upgrading the at least one new competence at the entity. The method may further include notifying the entity of the prediction and performing at least one of a sunsetting or adding action.

### BACKGROUND

Aspects of the present invention relate generally to advanced data-driven service evolution ecosystem management and, more particularly, to personalized cloud solution technologies, service lifecycle management systems and methods.

A cloud service ecosystem refers to the interconnected network of cloud-based services, providers, and users that collaboratively deliver, consume, and manage cloud resources and solutions. This ecosystem encompasses a variety of service models, including Infrastructure as a Service (IaaS), Platform as a Service (PaaS), and Software as a Service (SaaS), along with ancillary services such as security, monitoring, and support. Key players in this ecosystem include cloud service providers, third-party vendors offering specialized services, integrators who help tailor cloud solutions to specific business needs, and end-users ranging from individuals to large enterprises.

The cloud service ecosystem thrives on the interdependency and collaboration among its participants. Providers continuously develop and upgrade their offerings to meet evolving demands, while third-party vendors enhance functionality through additional tools and services. This dynamic interaction provides an ever-changing landscape and ecosystem.

### SUMMARY

In a first aspect of the invention, there is a computer-implemented method including: receiving, by a processor set, first data inputs related to an entity; determining, by the processor set based on the first data inputs, at least one service to sunset from a list of services related to the entity; generating, by the processor set based on the first data inputs, recommendations comprising ranked services to add to the list of services related to the entity; determining, by the processor set based on the recommended ranked services, at least one new competency as a candidate for upgrading at the entity; predicting, by the processor set, an overall impact to the entity by based on at least one of sunsetting the at least one service, adding at least one service of the ranked services, and upgrading the at least one new competence at the entity; notifying the entity of the prediction; and performing at least one action based on the prediction.

In another aspect of the invention, there is a computer program product including one or more computer readable storage media having program instructions collectively stored on the one or more computer readable storage media. The program instructions are executable to: receive first data inputs related to an entity; determine, based on the first data inputs, at least one service to sunset from a list of services related to the entity; generate, based on the first data inputs, recommendations comprising ranked services to add to the list of services related to the entity; determine, based on the recommended ranked services, at least one new competency as a candidate for upgrading at the entity; predict an overall impact to the entity based on at least one of sunsetting the at least one service, adding at least one service of the ranked services, and upgrading the at least one new competence at the entity; notify the entity of the prediction; and perform at least one action based on the prediction.

In another aspect of the invention, there is a system including a processor, a computer readable memory, one or more computer readable storage media, and program instructions collectively stored on the one or more computer readable storage media. The program instructions are executable to: receive first data inputs related to an entity; determine, based on the first data inputs, at least one service to sunset from a list of services related to the entity; generate, based on the first data inputs, recommendations comprising ranked services to add to the list of services related to the entity; determine, based on the recommended ranked services, at least one new competency as a candidate for upgrading at the entity; predict an overall impact to the entity based on at least one of sunsetting the at least one service, adding at least one service of the ranked services, and upgrading the at least one new competence at the entity; notify the entity of the prediction; and perform at least one action based on the prediction.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

FIG. 6 shows an exemplary flow diagram of an exemplary method in accordance with aspects of the invention.

FIG. 7 shows an exemplary flow diagram of an exemplary method in accordance with aspects of the invention.

FIG. 8 shows an exemplary flow diagram of an exemplary method in accordance with aspects of the invention.

FIG. 9 shows an exemplary flow diagram of an exemplary method in accordance with aspects of the invention.

FIG. 10 shows an exemplary flow diagram of an exemplary method in accordance with aspects of the invention.

FIG. 11 shows an exemplary flow diagram of an exemplary method in accordance with aspects of the invention.

### DETAILED DESCRIPTION

Aspects of the present invention relate generally to advanced data-driven service evolution ecosystem management and, more particularly, to personalized cloud solution technologies, service lifecycle management systems and methods. According to aspects of the present invention, the system may provide tailored cloud service recommendations, identify new opportunities in cloud management, strategically sunset inefficient and underutilized services, and bridge skill gaps between an entity's competencies and its needs.

According to an aspect of the present invention, there is a computer-implemented method for evaluating operational maturity, the method including: receiving a plurality of inputs including customer data, service provider data, competency data, external data, and feedback data; generating, by a tailored cloud services recommender and based on the inputs, recommendations including a set of new cloud services to offer, a set of cloud services to sunset, and a set of competencies to upgrade; receiving, based on the set of new cloud services to offer, a second set of feedback data and a second set of customer data; receiving, based on the set of new cloud services to offer and the set of cloud services to sunset, a second set of service provider data; receiving, based on the set of competencies to upgrade, a second set of competency data; predicting, based on the plurality of recommendations, a business value estimate, an operational impact, and a competency upgradation; and notifying a user of the predictions.

According to an aspect of the present invention, the business value estimate prediction may further predict business growth, customer impact, and deal success rate. According to an aspect of the present invention, the operational impact prediction may further predict technology stack capabilities, technological resource requirements, personnel resource requirements, and cost. According to an aspect of the present invention the competency upgradation prediction may further predict technological resource requirements, cost, and technology stack capabilities.

In known systems, cloud service ecosystems thrive on the interdependency and collaboration among its participants. In known systems, providers continuously develop and upgrade their offerings to meet evolving demands, while third-party vendors enhance functionality through additional tools and services. This dynamic interaction in known systems provide an ever-changing landscape and ecosystem. As a result, in known systems, outdated or slow-to-evolve cloud service ecosystem poses several significant problems including reduced competitiveness, increased security vulnerability, poor performance, poor scalability, outdated workforce skills and competencies, higher costs, underutilized services and resources, loss of talent, loss of market share, and/or any combination thereof. For example, a stagnating ecosystem in known systems can lead to a lack of new features, services, and technological advancements. The stagnation in known systems and ecosystems make it difficult for businesses to stay competitive, as they may miss out on the latest tools and technologies that could drive innovation and efficiency. In another example, an outdated infrastructure and/or workforce of known may struggle to handle growing workloads and demands, leading to performance bottlenecks, downtime, and reduced scalability. This can negatively impact user experience in known systems and limit an entity's ability to grow and adapt to changing business needs.

Embodiments and aspects of the present invention provide a system and method that improves technology in a specific and practical application. In other words, embodiments and aspects of the present invention improve personalized cloud solution technologies, service lifecycle management systems and methods, and better align services with emerging technology trends. For example, according to aspects of the present invention, the system and method may provide tailored cloud service recommendations, identify new opportunities in cloud management, strategically sunset inefficient and underutilized services, and bridge skill gaps between an entity's competencies and its needs. Each of these aspects, alone and in combination, help improve personalized cloud solution technologies, service lifecycle management systems and methods, and better align services with emerging technology trends by providing a system that can dynamically adjust service portfolios in response to evolving user needs and technological advancements.

A large enterprise typically relies on a cloud-based infrastructure to support its operations. Over time, the enterprise's cloud ecosystem becomes outdated due to the rapid evolution of technology and changing business needs. This stagnation leads to performance bottlenecks, security vulnerabilities, and inefficiencies due to underutilized services and an outdated workforce.

By applying the present invention, the system analyzes the enterprise's current cloud service usage, business needs, and technological trends. In embodiments, the present invention then generates tailored recommendations for upgrading or replacing specific cloud services, identifies opportunities to integrate new, cutting-edge technologies, and suggests which underperforming or outdated services should be sunset. In embodiments, the present invention may also recommend targeted training programs to bridge skill gaps in the workforce, ensuring the team can effectively manage and leverage the updated cloud services. As a result, the enterprise's infrastructure becomes more secure, scalable, and aligned with modern technology trends. Performance improves, costs are optimized, and the business can more effectively compete in the market by quickly adapting to new demands and opportunities. These exemplary embodiments and aspects illustrate how the present invention provides a specific and practical application by dynamically enhancing service management, thereby improving overall business performance and technology alignment.

Implementations of the present invention are necessarily rooted in computer technology. For example, at least determining, by the processor set based on the first data inputs, at least one service to sunset from a list of services related to the entity; generating, by the processor set based on the first data inputs, recommendations comprising ranked services to add to the list of services related to the entity; determining, by the processor set based on the recommended ranked services, at least one new competency as a candidate for upgrading at the entity; and predicting, by the processor set, an overall impact to the entity by based on at least one of removing the at least one service to sunset, adding at least one service of the ranked services, and upgrading the at least one new competence at the entity, is computer-based, is very complex, and cannot be performed in the human mind. Given the scale and complexity required to perform the foregoing tasks, it is simply not possible for the human mind, or for a person using pen and paper, to perform the number of calculations involved in performing structured and unstructured large language model (LLM) algorithms capable of prompted text generation. For example, LLMs have billions of parameters, including business data. These parameters are the weights and biases in the neural network that the model learns about the ingested business data during training to gain a deep understanding of a business's goals, needs, priorities, etc. Managing and optimizing such a large number of parameters is computationally intensive and requires advanced techniques. The underlying architecture involves complex layers like attention mechanisms, which are sophisticated and require careful tuning. Accordingly, performing LLM algorithms is beyond what a human mind can perform in real-time due to computational complexity and intensity.

Furthermore, using a machine learning model is, by definition, performed by a computer and cannot practically be performed in the human mind (or with pen and paper) due to the complexity and massive amounts of calculations involved. Given this scale and complexity, it is simply not possible for the human mind, or for a person using pen and paper, to perform the number of calculations involved in using a machine learning model.

It should be understood that, to the extent implementations of the present invention collect, store, or employ personal information provided by, or obtained from, individuals (for example, any cloud managed services and/or data that may include personal information and preferences, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

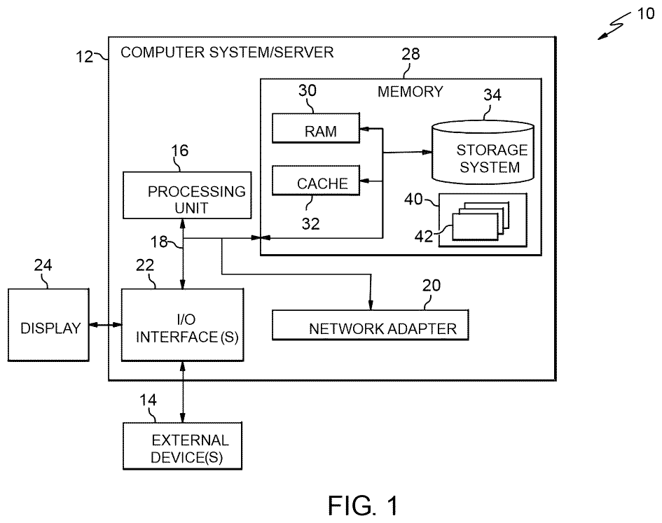

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system.

Generally, program modules may include routines, programs, objects, components, logic, data structures, and so on that perform particular tasks or implement particular abstract data types.

Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to microcode, device drivers, redundant processing units, external disk drive arrays, RAID systems, tape drives, and data archival storage systems, etc.

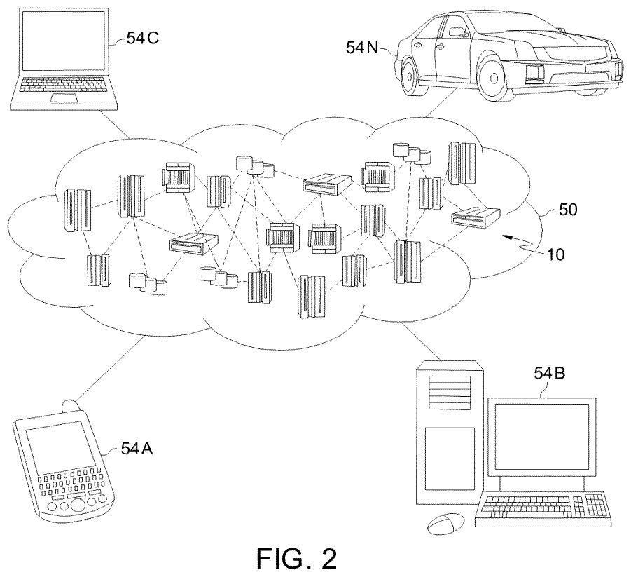

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

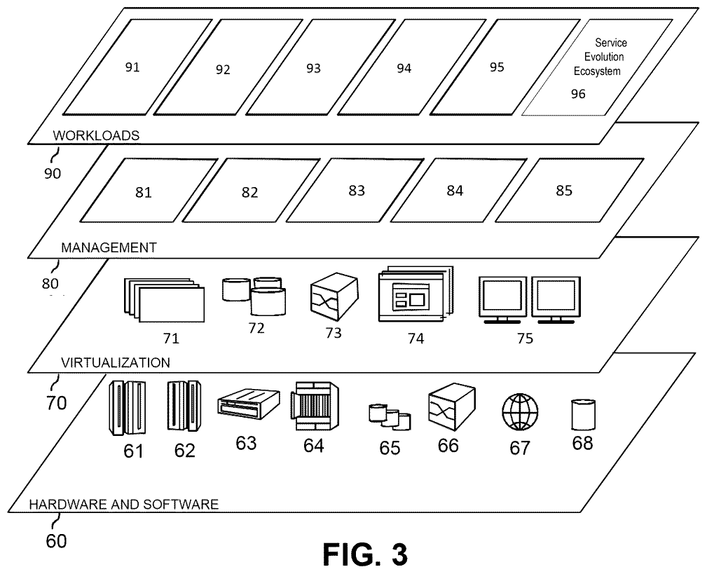

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the present invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and operational recommendation 96.

Implementations of the present invention may include a computer system/server 12 of FIG. 1 in which one or more of the program modules 42 are configured to perform (or cause the computer system/server 12 to perform) one of more functions of the service evolution ecosystem 96 of FIG. 3. For example, the one or more of the program modules 42 may be configured to: obtain a plurality of data types from an aggregation of data sources; segment the plurality of data types; generate at least one capability maturity score by evaluating a capability of at least one data source of the aggregation of data sources; generate at least one provider maturity score by evaluating a provider associated with the at least one data source of the aggregation of data sources associated with a specific provider; generate, using a machine learning algorithm, a set of recommendations based on a combination of the at least one capability maturity score and the at least one provider maturity score by iteratively simulating a plurality of modified capabilities and determining one or more steps to increase an operational maturity; rank the set of recommendations based at least partially on a predicted change in the operational maturity in response to implementing the set of recommendations; and prepare a report for a user, the report comprising an a determined explanation of the predicted change in the operational maturity in response to implementing the set of recommendations.

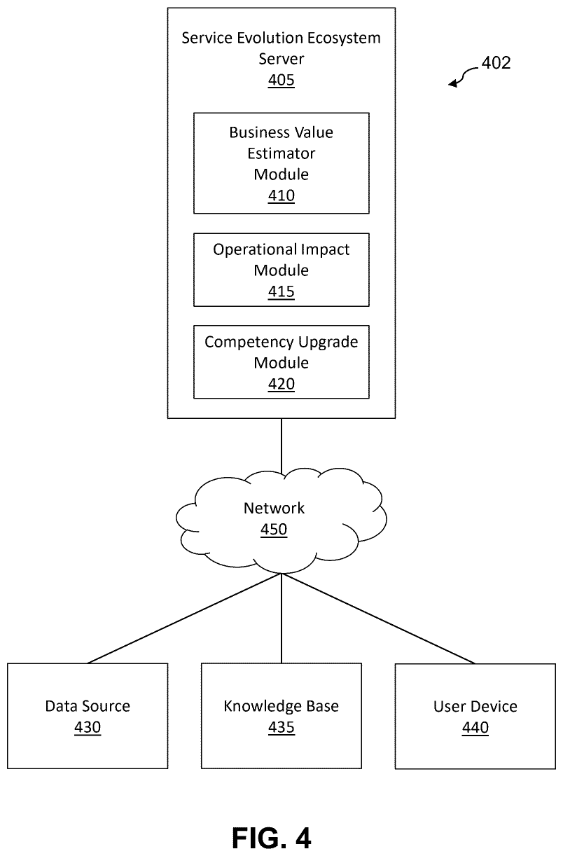

FIG. 4 shows a block diagram of exemplary environment 402 in accordance with aspects of the present invention. In embodiments, the environment includes service evolution ecosystem server 405, data source 430, knowledge base 435, user device 440, and network 450.

Service evolution ecosystem server 405 may comprise one or more instances of computer system/server 12 of FIG. 1. In another example, service evolution ecosystem server 405 may comprise one or more virtual machines or containers running on one or more instances of computer system/server 12 of FIG. 1. In embodiments, service evolution ecosystem server 405 communicates with data source 430, knowledge base 435, and user device 440 via network 450, which may comprise cloud computing environment 50 of FIG. 2. In embodiments, data source 430 comprises one or more instances of hardware and software components of hardware and software layer 60 of FIG. 3. In embodiments, knowledge base 435 comprises one or more instances of hardware and software components of hardware and software layer 60 of FIG. 3. In embodiments, user device 440 comprises an instance of an end user device such as, for example, personal digital assistant (PDA) or cellular telephone 54A, desktop computer 54B, laptop computer 54C, and/or automobile computer system 54N of FIG. 2. In embodiments, there may be plural different instances of user device 440. The different instances of user device 440 may be used by different users, product managers, system administrators, and/or other users that may access evolution ecosystem server 405, respectively.

In embodiments, service evolution ecosystem server 405 comprises business value estimator module 410, operational impact module 415, and competency upgrade module 420, each of which may comprise one or more program modules such as program modules 42 described with respect to FIG. 1. Service evolution ecosystem server 405 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In accordance with aspects of the present invention, business value estimator module 410 may be configured to generate recommendations comprising ranked services to add to the list of services related to the entity (e.g., a customer, user, and/or consumer) based on the first data inputs. In embodiments, a service or list of services are related to the entity when that entity uses, subscribes to, and or otherwise relies on the service or list of services. As used herein in the embodiments, ranked services comprise a plurality of services to add to the list of services related to the entity (e.g., a customer, user, and/or consumer). In embodiments, the service having the greatest positive impact on entity's business goals may be given the highest rank. Similarly, the service having the smallest positive impact on entity's business goals may be given the lowest rank. In embodiments, the ranked services may comprise one of the top three services, the top five services, the top ten services, or any other number of ranked services based on an entity's predetermined preference.

In embodiments, business value estimator module 410 is further configured to collect summary information comprising one or more of a browsed item summary (e.g., summaries for items viewed and considered by the entity, customer, user, and/or consumer), candidate summaries including summaries of the candidate services being ranked, and/or a customer summary including a summary of the customer's business efforts, needs, current services, and more. In embodiments, business value estimator module 410 may further use the collected summary information to generate a prompt for the LLM. As used herein, a prompt in an LLM serves as the input that guides the model in generating an explanation. The quality, relevance, and detail of a generated explanation depend on how well the prompt is formulated, as it influences the model's interpretation and response. In embodiments, the generated explanation may be stored, mapped, paired, and/or otherwise associated to the recommendation.

In embodiments, operational impact module 415 may be configured to determine at least one service to be removed and/or sunset, or to be marked for removal and/or sunsetting, from a list of services related to the entity (e.g., a customer, user, and/or consumer) based on the first data inputs. As used herein, sunsetting refers to the software being phased out or retired from active development and support. In embodiments, sunsetting also comprises a gradual process where the software will no longer receive updates, new features, or patches, and will eventually not be supported. As used herein, a service to be removed (or marked for removal) is a service that is used infrequently, performs poorly, outdated, expensive, and/or any other reason an entity would no longer wish to use for some other business purposes, such as poor efficiency or performance, budget, competency, and/or manpower. In embodiments, operational impact module 415's determination to remove the service is further (or alternatively) based on a revenue impact efficiency calculation. In such embodiments, the revenue impact efficiency (RIE) is calculated by multiplying aa revenue obtained from a service (R) with the sum of a workforce (W) affected by the service and the customers (C) affected, which is then multiplied by the effort (E) required to remove and/or sunset the service. In other words, in such embodiments, the revenue impact efficiency=R×(W+C)×E.

In embodiments, operational impact module 415 provides a determination of at least one service to be removed and/or sunset, or to be marked for removal and/or sunsetting, from a list of services related to the entity (e.g., a customer, user, and/or consumer) and may comprise a feedback loop. In other words, the output or result of the operational impact module 415 is fed back into the system as input, creating a cycle of continuous improvement or adjustment. In the context of the operational impact module 415, the feedback loop involves using the outcomes or performance data of existing services to inform decisions about which services should be removed, sunset, or marked for future removal. The feedback in this loop serves as a second data input by providing real-time or historical performance data, user satisfaction, usage statistics, or other relevant metrics related to the services. This data is analyzed to determine the effectiveness or relevance of each service, and if certain services underperform or no longer meet the entity's needs, the feedback prompts their removal or sunsetting. Essentially, the feedback loop ensures that decisions are continuously refined based on actual performance, making the system more responsive and adaptive to changes.

In embodiments operational impact module 415 may be further configured to evaluate external data which may include market data and analyst data to determine market trends that may affect the entity. As used herein, external data refers to information that comes from outside an entity and is used to enhance decision-making, such as when the decision-making involves understanding the broader environment in which the entity operates. When it comes to determining market trends that may affect an entity, external data can include a variety of sources such as market research reports, sales and pricing data, consumer data, competitor data, financial analyst reports, industry analysis, economic forecasts, and more.

In embodiments, the trend analysis may include a strengths, weaknesses, opportunities, and threats (SWOT) analysis that measures, or otherwise determines, the strengths, weaknesses, opportunities, and threats associated with the services related to the entity. In such embodiments, the SWOT analysis is performed by service evolution ecosystem server 405 and is sent to and/or obtained by operational impact module 415. As used herein, a SWOT analysis is a strategic planning tool used to evaluate a business, project, and/or a software service. For example, the strengths analysis may consider the revenue generating zones of the services, strong brand reputation, extensive expertise, and others. The weakness analysis may consider the number of competitors that have withdrawn from a specific service, limited consulting capabilities, and/or dependence on legacy infrastructure contracts. The opportunities analysis may consider areas where competitors are rapidly investing time, money, and/or resources into a specific service. The threats analysis may consider competitive pressures.

In embodiments, competency upgrade module 420 may be configured to determine at least one new competency as a candidate for upgrading the entity based on the recommendations comprising ranked services. In embodiments, competencies may include risk management services, market research services, internet of things (IoT) integration, sensor integration, edge security services, privacy services, and/or any other service that might improve the strengths, weaknesses, opportunities, and/or threats of the entity. In embodiments the SWOT analysis, as described above, is performed by service evolution ecosystem server 405 and may be shared with, distributed to, or obtained by operational impact module 415 and/or competency upgrade module 420.

In embodiments competency upgrade module 420 may measure the technology stack, an amount of effort to implement a new competency, a cost to implement a new competency, possible resources required for implementing a new competency, and/or how the entity/customer's workforce might be affected by implementing a new competency. As used herein, a technology stack is a combination of software tools, programming languages, frameworks, and technologies used to build and run an application or system. The choice of a technology stack is critical as it impacts the application's performance, scalability, and maintainability. In embodiments, competency upgrade module 420 may measure the technology stack by evaluating its performance, scalability, flexibility, and suitability for specific tasks or environments. Accordingly, the competency upgrade module 420 may measure the technology stack through metrics like response time, throughput, resource usage, ease of integration, development speed, maintainability, and how well it meets business or project goals.

As used herein, competency is a measure of the entities ability to carry out and/or take advantage of services related to the entity. For example, if an entity has a subscription for a unique database management service, competency may measure the entity's abilities (e.g., personnel, infrastructure, understanding, training, etc.) to carry out and utilize the unique database management service to its fullest extent. In embodiments, competency upgrade module 420 may determine the amount of effort to implement a new competency by assessing several factors that collectively estimate the time, resources, and complexity involved in implementing the new competency. For example, competency upgrade module 420 may identify the difference between the current capabilities and the desired competency, assess the extent of training, hiring, or reskilling needed to close this gap, estimate the number of personnel, time, and financial resources required to develop the new competency, evaluate how complex it is to integrate the new competency into existing systems, processes, and workflows, and more.

In embodiments, competency upgrade module 420 may further determine how the entity/customer's workforce might be affected by implementing a new competency by assessing current skill levels of employees in relation to the new competency, identifying which roles will require new skills or knowledge and the extent of training needed, analyze how the new competency will alter existing roles, responsibilities, and workflows, evaluate the potential increase or shift in workload, and more.

In this manner, competency upgrade module 420 may determine which competency may provide the greatest impact (e.g., improvement) to the entity's desired outcomes. In embodiments, the competency upgrade having the greatest impact may be ranked as the top potential new competency, whereas a competency upgrade having the lowest impact may be ranked as the lowest potential new competency. In embodiments, an entity's desired outcome can be determined by analyzing input data that reflects the organization's goals, such as performance metrics, strategic objectives, or specific business needs. Business value estimator module 410 may also (or alternatively) identify an entity's desired outcomes by analyzing information from various resources that describe the organization, such as mission statements, strategic goals, annual reports, and internal communications. These documents often outline the key objectives the entity aims to achieve, such as increasing market share, improving customer satisfaction, or enhancing operational efficiency. By examining this information, the competency upgrade module 420 can identify which competencies align most closely with these goals.

In embodiments, the ranked services are ranked based on a weighted average score determined based on affinity scores for services considered and an item (e.g., a service) relevance score for a specific customer (e.g., entity). In embodiments, the affinity score is determined by a functional affinity recommender. In other words, the system may use the available service offerings as input into a functional affinity recommender that determines an association strength score based on item summaries, large language application program interface, and/or functional associations. The functional affinity recommender may further perform item-function mapping and item-item affinity mapping to determine the affinity score. In such embodiments, the affinity score is a decimal between 0 and 1.

In embodiments, business value estimator module 410 may be configured to determine an item relevance score for a specific customer using a collaborative filtering recommender. In other words, the system may use the available service offerings and customer (i.e., entity) data as inputs and may employ an affinity matrix to determine relationships between customers and items such as customer subscriptions and interactions. As such, the collaborative filtering recommender may predict an interest based on customer similarities. In embodiments, the collaborative filtering recommender is a submodule of business value estimator module 410.

In embodiments, service evolution ecosystem server 405 is configured to notify a network administrator, a service provider, and/or the entity of the prediction. In embodiments, the notification includes the overall impact prediction and includes a recommendation to remove the at least one service marked for removal, add at least one service of the ranked services, upgrade the at least one new competency at the entity, or any combination thereof. In embodiments the notification is sent via email, text, and/or instant message. The notification may also be sent through an application, an application program interface (API), a system dashboard, or any other digital location where a network administrator, service provider, and/or entity receives communications.

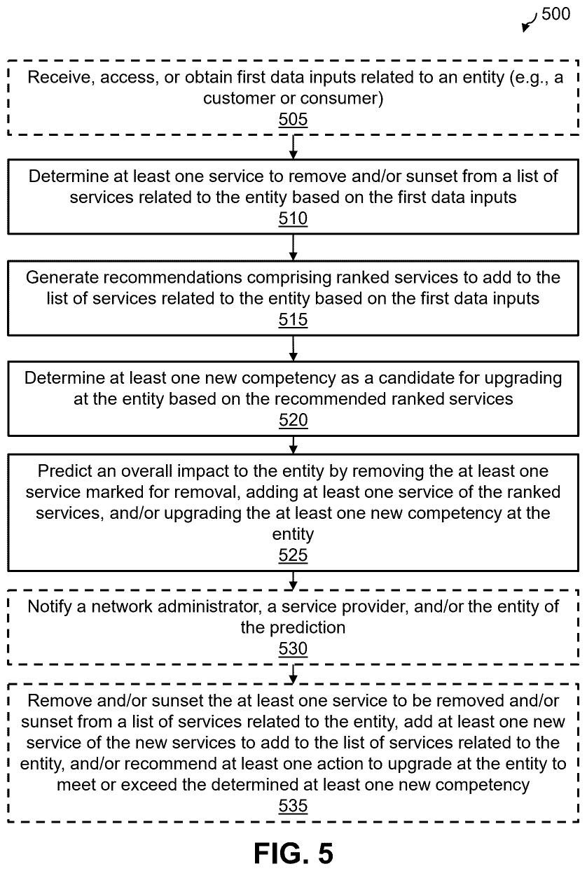

FIG. 5 shows a flowchart of an exemplary method 500 in accordance with aspects of the present invention. Steps of the method may be carried out in the environment of FIG. 4 and are described with reference to elements depicted in FIG. 4.

At block 505, service evolution ecosystem server 405 of FIG. 4 is optionally configured (as indicated by the dotted line) to receive, access, or obtain first data inputs related to an entity (e.g., a customer, user, and/or consumer). In embodiments, first data inputs may include entity data such as subscriptions for data services, entity, customer, user, consumer activity, infrastructure related to the entity, demographics of the entity, and any other data that describes the entity and can be used to better determine services that may help and/or is hindering the efficiency or value of the entity. In embodiments, the first data inputs may also include service provider data including a list of one or more services that are provided by the service provider, partners of the service provider, and/or any other data that describes the service provider and can be used to assess the service provider's offerings and abilities. In embodiments, the first data inputs may comprise data related to at least one cloud computing environment. As used herein, a cloud computing environment, as used herein, is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. For example, in embodiments, customers may subscribe to a provider's cloud computing services such as servers, applications, tools, storage, databases, and use and/or access those services over a network.

In embodiments, the first data inputs may include competencies of the entity. As used herein in the embodiments, competency is a measure of the entities ability to carry out and/or take advantage of services related to the entity. For example, if an entity has a subscription for a unique database management service, competency may measure the entity's abilities (e.g., personnel, infrastructure, understanding, training, etc.) to carry out and utilize the unique database management service to its fullest extent.

At block 510, operational impact module 415 of FIG. 4 is configured to determine at least one service to mark for removal and/or for sunsetting from a list of services related to the entity based on the first data inputs. As explained above, a service marked for removal is a service that is used infrequently, performs poorly, outdated, expensive, and/or any other reason an entity would no longer wish to use for some other business purpose, such as poor efficiency or performance, budget, competency, and/or manpower. In embodiments, the operational impact module 415 determination to remove the service is further (or alternatively) made based on a revenue impact efficiency calculation. In such embodiments, the revenue impact efficiency (RIE) is calculated by multiplying a revenue obtained from a service (R) with the sum of a workforce (W) affected by the service and the customers (C) affected, which is then multiplied by the effort (E) required to sunset the service. In other words, in such embodiments, the revenue impact efficiency=R×(W+C)×E.

In embodiments, the operational impact module 415 determination to remove the service is further (or alternatively) based on one or more trend analyses. For example, operational impact module 415 may evaluate external data which may include market data and analyst data to determine market trends that may affect the entity. In embodiments, the trend analysis may include a SWOT analysis. In embodiments, the SWOT analysis is performed at service evolution ecosystem server 405 and made available to operational impact module 415. As provided above, a SWOT analysis performed at service evolution ecosystem server 405 measures, or otherwise determines, the strengths, weaknesses, opportunities, and threats associated with the services related to the entity. For example, the strengths analysis may consider the revenue generating zones of the services, strong brand reputation, extensive expertise, and others. The weakness analysis may consider the number of competitors that have withdrawn from a specific service, limited consulting capabilities, and/or dependence on legacy infrastructure contracts. The opportunities analysis may consider areas where competitors are rapidly investing time, money, and/or resources into a specific service. The threats analysis may consider competitive pressures.

At block 515, business value estimator module 410 is configured to generate recommendations comprising ranked services to add to the list of services related to the entity based on the first data inputs. As explained above, ranked services comprise a plurality of services to add to the list of services related to the entity (e.g., a customer, user, and/or consumer). In embodiments, the service having the greatest positive impact on entity's business goals may be given the highest rank. Similarly, the service having the smallest positive impact on entity's business goals may be given the lowest rank.. In embodiments, the ranked services may comprise one of the top three services, the top five services, the top ten services, or any other number of ranked services based on an entity's predetermined preference.

In embodiments the ranked services are ranked based on a weighted average score determined based on affinity scores for services considered and an item (e.g., a service) relevance score for a specific customer (e.g., entity). In embodiments, the affinity score is determined by a functional affinity recommender. That is, the system may use the available service offerings as input into a functional affinity recommender that determines an association strength score based on item summaries, large language application program interface, and/or functional associations. The functional affinity recommender may further perform item-function mapping and item-item affinity mapping to determine the affinity score. In such embodiments, the affinity score is a decimal between 0 and 1.

In embodiments, the business value estimator module 410 determines an item relevance score for a specific customer using a collaborative filtering recommender as part of ranking the available services. In other words, the system may use the available service offerings and customer (i.e., entity) data as inputs and may employ an affinity matrix to determine relationships between customers and items such as customer subscriptions and interactions. As such, the collaborative filtering recommender may predict an interest based on customer similarities and may use the interest as a factor in determining the service's rank. In embodiments, the collaborative filtering recommender is a submodule of business value estimator module 410.

In embodiments, the weighted average score (i.e., bagging) is weighted based on the amount of data known about the entity/customer. For example, when an entity is newly onboarded and/or there is relatively little data about the entity, a higher weight may be given to the affinity score by a functional affinity recommender. In embodiments, the functional affinity recommender is a submodule of business value estimator module 410. When more data is collected about the entity and/or when the entity's preferences are more established, the weighting of the item relevance score increases. As used herein, onboarding refers to the process of transitioning a new entity (e.g., a customer, user, and/or consumer) onto the service platform. For example, the system may know little about an entity that has just transitioned onto the service platform, so more weight is given to the affinity score until more data is collected about the newly onboarded entity.

In embodiments, the recommendations generated by business value estimator module 410 at block 515 further comprise an explanation for one, a subset, or all the recommendations. In such embodiments, the explanation may be generated using an LLM. In embodiments, an LLM capable of prompted text generation may output text in a structured format (e.g., having lists, tables, bullet points, structured text with headings and subheadings, and/or any format indicated by an entity) and/or in an unstructured format (i.e., without a specific format, bullet points, or sections). In embodiments such LLMs may utilize a decoder-only transformer architecture, which is pre-trained on large text corpuses. While many LLMs rely on the foregoing architecture, embodiments described herein are not limited to this example. In other words, the LLMs may have a different generative text model with linguistic fluency and domain relevant pre-training to reliably obtain the specified outputs. In embodiments, the specific LLM implementation may be selected from a group consisting of: OpenAI's GPT-4, Google's GEMINI, Meta's LLAMA3®, and Anthropic's CLAUDE3.

In embodiments, business value estimator module 410 may collect summary information comprising a browsed item summary including summaries for items viewed and considered by the entity/customer, candidate summaries including summaries of the candidate services being ranked, and/or a customer summary including a summary of the customer's business efforts, needs, current services, and more. Business value estimator module 410 may use the collected summary information and use it to generate a prompt for the LLM. The generated explanation may be stored, mapped, paired, and/or otherwise attached to the associated recommendation.

At block 520, competency upgrade module 420 of FIG. 4 is configured to determine at least one new competency as a candidate for upgrading at the entity based on the recommended ranked services. In embodiments, competencies may include risk management services, market research services, internet of things integration, sensor integration, edge security services, privacy services, and/or any other service that might improve the strengths, weaknesses, opportunities, and/or threats of the entity.

In embodiments, competency upgrade module 420 may obtain or receive the results of a SWOT analysis from service evolution ecosystem server 405. The SWOT analysis measures, or otherwise determines, the strengths, weaknesses, opportunities, and threats associated with the services related to the entity. For example, service evolution ecosystem server 405's strengths analysis may consider the revenue generating zones of the services. Service evolution ecosystem server 405's weakness analysis may consider the number of competitors that have withdrawn from a specific service. Service evolution ecosystem server 405's opportunities analysis may consider areas where competitors are rapidly investing time, money, and/or resources into a specific service. In embodiments, and in addition to obtaining or receiving the SWOT analysis, competency upgrade module 420 may identify the entity/customer's competency with respect to the identified weaknesses, opportunities, and threats. In such embodiments, competency upgrade module 420 may employ an LLM to identify the entity/customer's competency and may provide an explanation for the identified competencies. In embodiments, the specific LLM used by competency upgrade module 420 may be selected from a group consisting of: OpenAI's GPT-4, Google's GEMINI, Meta's LLAMA3®, and Anthropic's CLAUDE3.

In embodiments, competency upgrade module 420's determining at least one new competency as a candidate for upgrading at the entity based on the recommended ranked services may further include performing an impact analysis where the competencies are ranked. In other words, competency upgrade module 420 may measure the technology stack, an amount of effort to implement a new competency, a cost to implement a new competency, possible resources required for implementing a new competency, and/or how the entity/customer's workforce might be affected by implementing a new competency, as described above. In this manner, competency upgrade module 420 may determine which competency may provide the greatest impact (e.g., improvement) to the entity's desired outcomes. In embodiments, the competency upgrade having the greatest impact may be ranked as the top potential new competency, whereas a competency upgrade having the lowest impact may be ranked as the lowest potential new competency. For example, a new competency that requires little relative effort to implement, is relatively cheaper to implement, and where the entity already has the necessary resourced to implement the new competency, this potential new competency would receive a higher ranking as compared with a potential new competency that would require a great relative effort and expense to implement and would require new/additional resourced to implement.

At block 525, service evolution ecosystem server 405 of FIG. 4 is configured to predict an overall impact to the entity by removing the at least one service marked for removal, adding at least one service of the ranked services, and/or upgrading the at least one new competence at the entity. In embodiments, the prediction includes one service to remove, one of the services to add, or one new competency to add. In additional embodiments, the prediction includes multiple services selected from one or more of the group of services to remove, services to add, and competencies to add. In such embodiments, the multiple services may be selected from the same category. In embodiments, the prediction may include multiple services selected from one category and no services from the other categories. In other embodiments, the prediction may include services selected from one of one category, two category, and three categories.

At block 530, service evolution ecosystem server 405 is optionally configured to notify a network administrator, a service provider, and/or the entity of the prediction. In embodiments, the notification includes the overall impact prediction and includes a recommendation to remove the at least one service marked for removal, add at least one service of the ranked services, upgrade the at least one new competency at the entity, or any combination thereof. In embodiments the notification is sent via email, text, and/or instant message. The notification may also be sent through an application, an application program interface (API), a system dashboard, or any other digital location where a network administrator, service provider, and/or entity receives communications.

At block 535, service evolution ecosystem server 405 is optionally configured to remove the at least one service marked for removal from a list of services related to the entity, add at least one new service of the new services to add to the list of services related to the entity, and/or recommend at least one action to upgrade at the entity to meet or exceed the determined at least one new competency. In other words, the service evolution ecosystem server 405 may be configured to perform a recommended action to achieve the desired outcome based on one or more of blocks 510-530 of FIG. 5. For example, in an embodiment, service evolution ecosystem server 405 may remove the at least one service marked for removal from a list of services related to the entity. In another embodiment, service evolution ecosystem server 405 may additionally (or alternatively) add at least one new service of the new services to add to the list of services related to the entity.

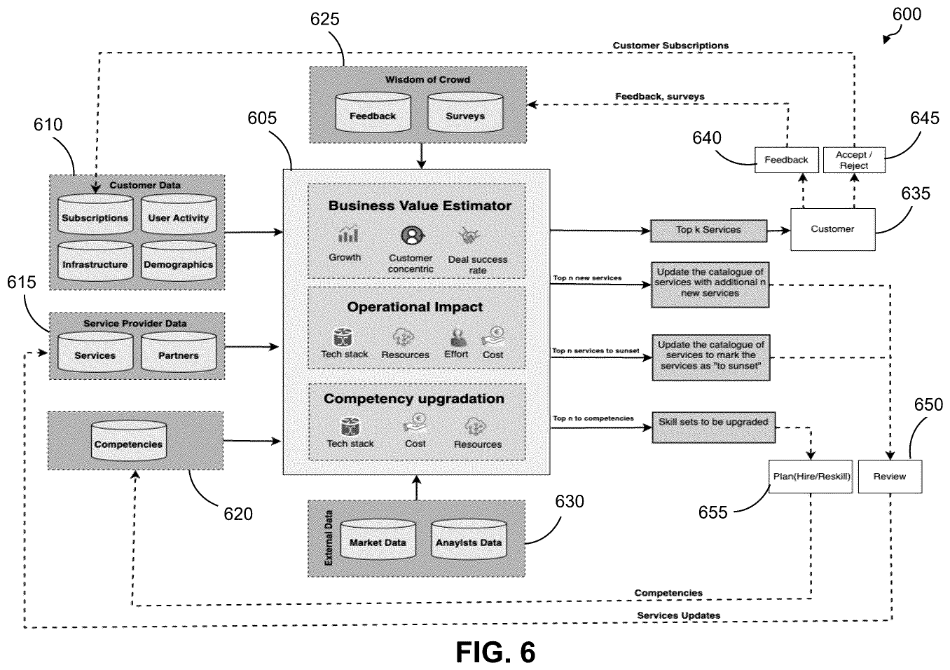

FIG. 6 shows an exemplary flow diagram 600 in accordance with aspects of the present invention. Steps of the method may be carried out in the environment of FIG. 4 and may include one or more blocks, as described with respect to method 500 of FIG. 5. For example, service evolution ecosystem server 605 (which may comprise one or more instances of service evolution ecosystem server 405 of FIG. 4) may receive inputs 610, 615, 620, 625, and 630. As explained above with respect to FIG. 5, inputs 610 may include, for example, customer (e.g., entity) data such as subscriptions for data services, entity, customer, user, and/or consumer activity, infrastructure related to the entity, demographics of the entity, and/or any other data that describes the entity and can be used to better determine services that may help and/or is hindering the efficiency or value of the entity.

In embodiments, inputs 615 may include, for example, service provider data including a list of one or more services that are provided by the service provider, partners of the service provider, and/or any other data that describes the service provider and can be used to assess the service provider's offerings and abilities. In embodiments, inputs 620 may include a list of an entity/customer's competencies. In embodiments, inputs 625 may include wisdom of a crowd (i.e., crowd-sourced data) that may be received from the entity, customers, users, consumers, and/or anyone with knowledge of the field. In such embodiments, the crowd-sourced data may include data received through feedback channels and/or via surveys. In embodiments, inputs 630 may include external data such as market data, analysis data, and/or any other external data that may provide strengths, weaknesses, opportunities, and/or threats related to services considered by service evolution ecosystem server 605. As disclosed above, external data refers to information that comes from outside an entity and is used to enhance decision-making, such as when the decision-making involves understanding the broader environment in which the entity operates. When it comes to determining market trends that may affect an entity, external data can include a variety of sources such as market research reports, sales and pricing data, consumer data, competitor data, financial analyst reports, industry analysis, economic forecasts, and more.

In embodiments, service evolution ecosystem server 605 comprises a business value estimator (which may comprise at least one instance of business value estimator module 410 of FIG. 4), an operational impact module (which may comprise at least one instance of operational impact module 415 of FIG. 4), and a competency upgradation module (which may comprise at least one instance of competency upgrade module 420 of FIG. 4).

According to aspects of the present invention, service evolution ecosystem server 605 is configured to output top recommended services in accordance with block 515 of FIG. 5. In embodiments, service evolution ecosystem server 605 is configured to update a catalogue of services with additional new services that are recommended for a particular customer (e.g., entity or enterprise) in accordance with block 535 of FIG. 5. In embodiments, service evolution ecosystem server 605 is further configured to update the catalogue of services by marking or otherwise indicating the services to be removed and/or to be sunset in accordance with blocks 510 and/or 535. As explained above, sunsetting refers to the software being phased out or retired from active development and support. In embodiments, this also comprises a gradual process where the software will no longer receive updates, new features, or patches, and eventually, it will no longer be supported. Whereas removal is a relatively immediate event.

In embodiments, the top new services may be presented to customer(s) 635 in accordance with block 530 of FIG. 5. Customers may be given an opportunity to provide feedback 640 and/or to accept or reject 645 the proposed new services. In either case, the customer feedback and/or the decision to accept or reject the proposed new services are used to further teach (i.e., instruct or inform) service evolution ecosystem server 605 by using the feedback and decision to accept or reject as inputs for another iteration of analyses.

In embodiments, the updates to the catalogue(s) (e.g., updating with the new services and/or the services to be sunset), are reviewed 650 before the service updates are made and before they are added to the service provider data associated with input 615. In other embodiments, these changes may be made automatically implemented without being reviewed. In other words, in response to the top services meeting a predetermined threshold score, the changes may be implemented without review.

In embodiments, plans 655 may be created to hire and/or reskill an entity's workforce to better match the skill sets and competencies that are to be upgraded. In embodiments, plans 655 may further include recommendations for specific skill sets, levels of experience, training programs, may be included in the plans for hiring and/or reskilling the workforce. For example, if new services being added are directed to security type products and the entity has relatively few security experts, plans 655 may include either hiring one or more security experts and/or recommend training existing employees to handle the security products.

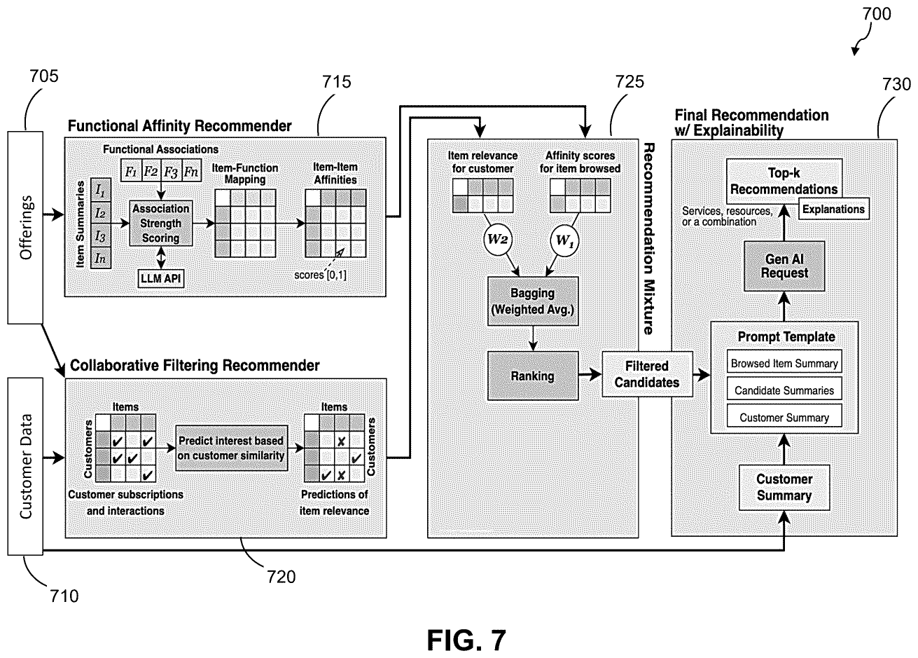

FIG. 7 shows exemplary flow diagram 700 in accordance with embodiments described herein. FIG. 7 illustrates a method for preparing a final recommendation for new services with an explanation for the recommendations. In embodiments, recommendations may be generated, at least in part, using the methods described with respect to one or more of blocks of FIG. 5.

As explained above, business value estimator module 410 of FIG. 4 may be configured to generate recommendations comprising ranked services to add to the list of services related to the entity based on the first data inputs. In embodiments the ranked services are ranked based on a weighted average score determined based on affinity scores for services considered and an item (e.g., a service) relevance score for a specific customer (e.g., entity). In embodiments, the affinity score is determined by functional affinity recommender 715. Functional affinity recommender 715 analyzes relationships between customers and services and does not presuppose significant data about the customer. In embodiments, the affinity score is determined based on offerings 705 (e.g., new services) that are available to the entity. In other words, the system may use the available service offerings 705 as input into functional affinity recommender 715. The functional affinity recommender 715 determines an association strength score based on item summaries, large language application program interface, and/or functional associations.

As used herein, item similarities refers to descriptions or representations of items that capture their essential attributes, features, or key information. As used herein, large language application program interface refers to an application program interface (API) that provides access to an LLM. As noted above, LLMs are advanced machine learning models trained on vast amounts of text data to understand and generate human-like text. These models can process and analyze text to extract meaning, identify relationships, and generate natural language responses. In this scenario, the Large Language API would be used to enhance functional affinity recommender 715 by analyzing item summaries, extracting relevant information, and understanding the context or nuances that might not be easily captured through traditional methods.

As used herein, a functional association refers to the relationship between items, entities, or concepts based on their roles, purposes, or functions within a specific context. In the context of the functional affinity recommender, this would mean analyzing how different items or elements are related or connected by the way they function or interact with each other, rather than just by surface similarities or shared attributes.

Functional affinity recommender 715 may further perform item-function mapping and item-item affinity mapping to determine the affinity score. In such embodiments, the affinity score is a decimal between 0 and 1.

In embodiments, the item relevance score for a specific customer is determined by collaborative filtering recommender 720 which is largely based on similarities between customers (e.g., entities). In other words, the system may use the available service offerings 705 and customer data 710 as inputs. Collaborative filtering recommender 720 may also use an affinity matrix to determine relationships between customers and items such as customer subscriptions and interactions. As used herein, an affinity matrix is a tool used to represent the similarity or relationship between different elements or items in a set, such as a similarity or relationship between customers and services. In embodiments, the affinity matrix is typically a square matrix where both rows and columns represent the same set of items or elements. In such embodiments, the value at the intersection of a row and a column indicates the level of affinity (similarity or relationship) between the corresponding items. As such, collaborative filtering recommender 720 may predict an interest based on customer similarities.

In embodiments, the weighted average score is weighted based on the amount of data known about the entity/customer by recommendation mixture module 725. For example, when an entity is newly onboarded and/or there is relatively little data about the entity, a higher weight may be given to the affinity score determined by a functional affinity recommender. When more data is collected about the entity and/or when the entity's preferences are more established, the weighting of the item relevance score increases. In response to ranking the potential new services, recommendation mixture module 725 generates a filtered list of potential new service candidates.

In embodiments, recommendation mixture module 725 may use bagging to produce the weighted average score. As used herein, bagging is a machine learning technique primarily used to improve the stability and accuracy of models by reducing variance and avoiding overfitting. In this context, bagging refers to combining the item relevance score and the affinity scores using a weighted average approach. In embodiments, the system is configured to aggregate multiple scores to get a more robust and accurate prediction or ranking.

As explained above, ranked services comprise a plurality of services to add to the list of services related to the entity (e.g., a customer, user, and/or consumer). In embodiments, the service having the greatest positive impact on entity's business goals may be given the highest rank. Similarly, the service having the smallest positive impact on entity's business goals may be given the lowest rank.. In embodiments, the ranked services may comprise one of the top three services, the top five services, the top ten services, or any other number of ranked services based on an entity's predetermined preference.

In embodiments, the filtered list of potential new service candidates is modified to include an explanation for one, a subset, or all of the recommendations at final recommendation module 730 (which may operate within at least one instance of business value estimator module 410 of FIG. 4). In such embodiments, the explanation may be generated using an LLM and/or a generative AI request. In embodiments, final recommendation module 730 may collect summary information at and/or using a prompt template, the summary information comprising a browsed item summary including summaries for items viewed and considered by the entity/customer, candidate summaries including summaries of the candidate services being ranked, and/or a customer summary including a summary of the customer's business efforts, needs, current services, and more.

Final recommendation module 730 may use the collected summary information and use it to generate a prompt for the LLM (e.g., a generative AI request). The generated explanation may be stored, mapped, paired, and/or otherwise attached to the associated recommendation. A generative AI request in this context involves collecting and summarizing data on items a customer has browsed, including details of viewed and considered services, as well as compiling candidate service summaries and a comprehensive customer profile. The AI analyzes these summaries and considers the customer's business needs, current services, and browsing behavior to generate top service recommendations. In this manner, final recommendation module 730 process leverages AI to provide tailored, data-driven suggestions that align closely with the customer's specific requirements and interests with explanations for the recommendations. Accordingly, in embodiments, final recommendation module 730 generates a final recommendation with explainability in accordance with blocks 515 and/or 525 of FIG. 5. As noted above, ranked services comprise a plurality of services to add to the list of services related to the entity (e.g., a customer, user, and/or consumer). In embodiments, the service having the greatest positive impact on entity's business goals may be given the highest rank. Similarly, the service having the smallest positive impact on entity's business goals may be given the lowest rank. In embodiments, the ranked services may comprise one of the top three services, the top five services, the top ten services, or any other number of ranked services based on an entity's predetermined preference.

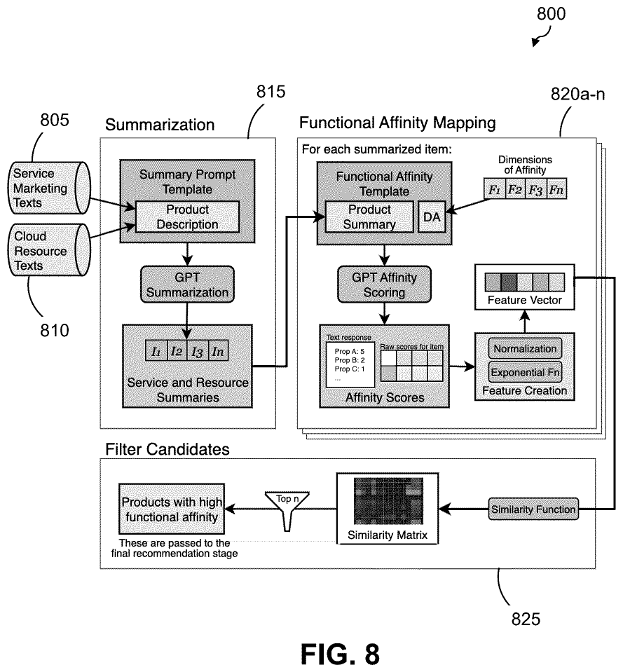

FIG. 8 shows an exemplary flow diagram 800 for calculating a feature weighting in accordance with embodiments described herein. Specifically, FIG. 8 illustrates a subroutine or sub-module of functional affinity recommender 715 of FIG. 7. Further, as described above with respect to block 515 of FIG. 5, functional affinity recommender 715 may determine at least one new service (e.g., products) having a relatively high functional affinity.

In embodiments, exemplary flow diagram 800 has three stages: summarization stage 815, functional affinity mapping stage(s) 820a-n, and filter candidate stage 825. In embodiments, summarization stage 815 receives and/or accesses service marketing texts 805 and cloud resource texts 810 to provide a product description to a summary prompt template. Using LLM (e.g., GPT summarization), summarization stage 815 outputs service and resource summaries that are inputted into functional affinity mapping stage(s) 820a-n. In embodiments, the output summary may be one sentence long and/or it may be subject to a word count limit. For example, the summary may be less than 10 words long. In embodiments, the specific LLM implementation may be selected from a group consisting of: OpenAI's GPT-4, Google's GEMINI, Meta's LLAMA3®, and Anthropic's CLAUDE3.

Functional affinity mapping stage(s) 820a-n iterates over the received summaries and places the summaries in a functional affinity template. In embodiments, the system uses the description of one of the products along with several dimensions of affinity for the functional affinity template. For example, a team having specific characteristics that are similar to the type of action performed by a product, that team may have an association such that it is more likely to use that product as a core frequent part of their operations. In embodiments, functional affinity mapping connects items in two sets, set A and set B, without requiring that the items are directly comparable. In such embodiments, the mapping relies on one or more sets of intermediary variables that bear a common relation to set A and set B. Further in such embodiments, each item of set A and set B are assigned a score indicating their degree of affinity to each intermediary variable. Therefore, similarity of any two items is determined by the similarity of their intermediary scores.

In embodiments, the functional affinity template indicates how scores are assigned and how to estimate the strength of a relationship between a given team, one of the dimensions of affinity, and the product. In embodiments, each of the product summaries are given an affinity score using a GPT scoring submodule. In other words, the GPT summarization, described above, is applied to the functional affinity template and scores are assigned based on the strength of a relationship between a team, one of the dimensions for affinity, and a product using a GPT affinity scoring submodule. The resulting score is an affinity score, indicating the strength of the association between each of the dimensions of affinity and the product, based on the GPT summarization inputs. In such embodiments, the given score may be between one and five.

Furthermore, the affinity scores are provided as a raw score, meaning, the score is relatively unprocessed and cannot be compared to other affinity scores until further analysis or interpretation has been applied.

After functional affinity mapping stage(s) 820a-n has scored all the items, the scores are normalized using a feature creation submodule, such that the affinity scores can be compared to other affinity scores. In embodiments, normalizing may comprise using exponential functions. As used herein, an exponential function is used to transform an existing affinity score by applying an exponential relationship, often to model non-linear patterns. In embodiments, exponential functions may be used to emphasize differences in values, magnifying larger values and shrinking smaller ones, thus capturing exponential trends in the data. In embodiments, the normalized data is stored in a feature vector.

Filter candidate stage 825 accepts the normalized scores and uses them in a similarity function to measure the relational distance between the items. In embodiments, the relational distance is measured using a cosine similarity. The results of the similarity function are entered into an affinity (i.e., similarity) matrix. In embodiments, the relational distance and/or the similarity matrix data may be used to determine, or help determine, the relative top products and/or products with high functional affinity. In this matter the system may provide recommendations across product categories. In other words, the system can make recommendations for both services and resources, because they are distinct types, and they are associated with different semantic domains. In other words, the functional affinity mapping detects services and resources that have similarities that would not otherwise appear to be similar. The functional affinity mapping approach overcomes limitations of content-based filtering, which presupposes direct comparability. For example, services and cloud resources are conceptually distinct but are functionally related categories. Inconsistent semantic overlap between descriptions of these items may belie their functional compatibility within an ecosystem of tools and architectural practices. The intermediary variables described above may capture this latent relationship using associations such as team roles, technology categories, or common use cases that may only be detectable when using the intermediary variables.

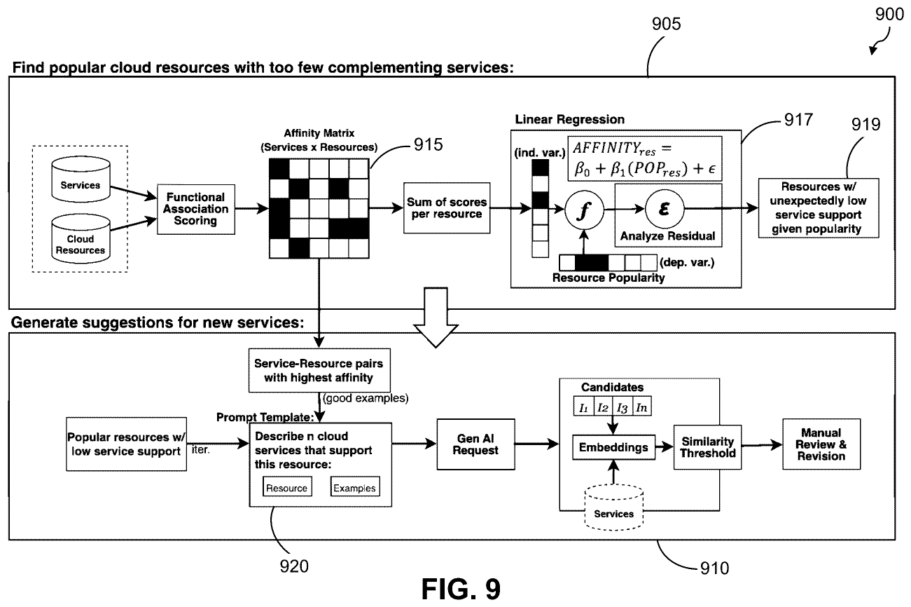

FIG. 9 shows an exemplary flow diagram 900 in accordance with embodiments described herein. Specifically, FIG. 9 illustrates an exemplary method for finding popular cloud resources with too few complimenting services 905 and generating suggestions for new services 910. In embodiments, the exemplary flow diagram 900 illustrates a method that can be performed in addition to the method described with respect to FIG. 8. In additional embodiments, the exemplary flow diagram 900 illustrates a method that can be performed as an alternative to the method described with respect to FIG. 8. According to aspects of the present invention, the method illustrated in FIG. 9 identifies gaps within a set of available products and/or services and proposes products and/or services that might fill those gaps and improve an entity's catalogue of products and services.

In embodiments, method for finding popular cloud resources with too few complimenting services 905 uses the inputs and functional association (i.e., affinity) scoring described with respect to FIG. 8. As illustrated, affinity matrix 915 is generated having services on one side of the matrix (e.g., x) and resources on the other side of the matrix (e.g., y). The value in each cell is a measure (e.g., a score) of the similarity of the respective services and products. In embodiments, the affinity score is calculated within a range of 0 to 1. The affinity score indicates how closely service and resources are associated with each other.

In embodiments the system may further calculate the sum of the score for each resource. For example, for a given resource the system may determine the number of services that functionally align with that resource. For example, a migration system for a database that appears to be popular because many users and/or entities use that migration system resource. In such instances, it might be assumed that a popular resource is relatively well supported by an ecosystem of services that are available. However, that may not always be true. In embodiments, the system may use linear regression 917 to find potential resources with unexpectedly low service support, given their popularity or given the number of users and/or entities that use the resource. As used herein, linear regression refers to a statistical method used to model the relationship between a dependent variable and one or more independent variables by fitting a linear equation to observed data. Linear regression finds the best-fitting straight line (known as the regression line) that minimizes the difference between the predicted and actual values. This method is used for predicting outcomes and understanding the strength and nature of relationships between variables. Thus, the system may use linear regression 917 to find potential resources with unexpectedly low service support, given their popularity or given the number of users and/or entities that use the resource.

When the outliers are found (i.e., resources with unexpectedly low service support 919), the system uses that information to determine new services that might perform a similar operation or satisfy a particular function that are adequately supported at suggestions for new services 910.

Using prompt template 920 (in accordance with the description of block 515 in FIG. 5), a large language model (LLM) algorithm may take service-resource pairs with relatively high affinities and popular resources with relatively low service support to generate a description of services that support the available resources. In embodiments the large language model (LLM) algorithm may also use a list of available resources and a list of provided examples to generate the AI request. In embodiments, the specific LLM implementation may be selected from a group consisting of: OpenAI's GPT-4, Google's GEMINI, Meta's LLAMA3®, and Anthropic's CLAUDE3.

In embodiments, after an AI request is generated, the system calculates a text embedding for the candidate services and/or resources and compares the calculated text embeddings with existing embeddings to make ensure that other services do not already occupy the same niche. In embodiments, the system may pass the calculated text embeddings after passing thru the similarity threshold for review and/or revision. As used herein, similarity threshold refers to a predefined metric or cutoff point used to determine how similar the calculated text embeddings of candidate services or resources are to existing embeddings. If the similarity between a new service/resource's embedding and existing embeddings exceeds this threshold, it indicates that the new service might be too similar to something that already exists, potentially occupying the same niche. If it falls below the threshold, the new service is considered sufficiently distinct. The system uses this threshold to decide whether to flag the service for further review, revision, or to proceed with its inclusion.

In embodiments, the review and/or revision may be performed manually by a system administrator, or it may be performed automatically by the system. In this manner, the system identifies gaps within the set of products that are offered and highlights areas where the catalogue of services could be improved.

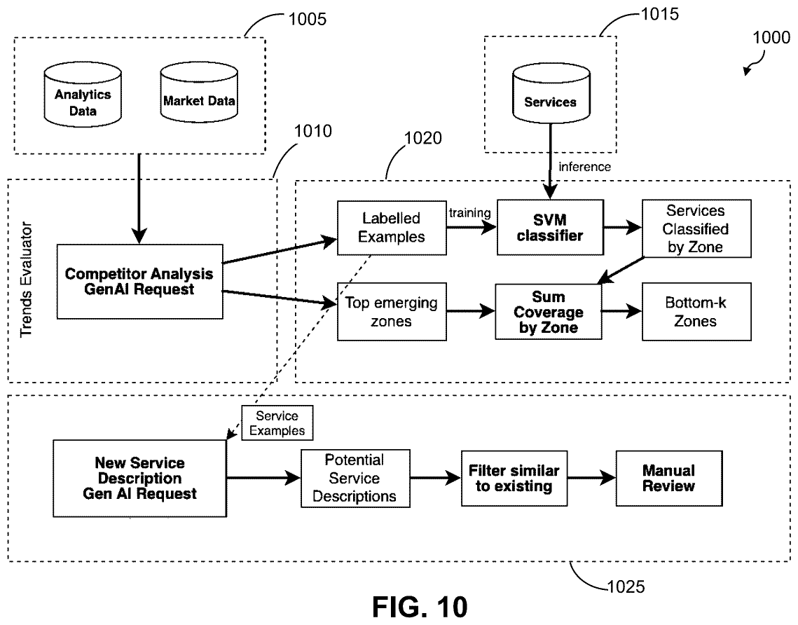

FIG. 10 shows an exemplary flow diagram 1000 in accordance with embodiments described herein. Specifically, FIG. 10 illustrates an exemplary method for analyzing competitor and market trends to determine emerging trends and/or products that competitors are using or starting to use. For example, trends evaluator 1010 received input data 1005 which, in embodiments, may include analytics data and market data to determine and/or generate recommendations for possible new services in accordance with block 515 of FIG. 5.

In embodiments, trends evaluator 1010 may output labeled examples and top emerging zones, such as areas where there is a lot of customer and/or competitor interest. Classification module 1020 may use the labeled examples to train a support vector machine (SVM) classifier to classify the services according to a labeling scheme of the labeled data and output the classified services. In embodiments, the classified services are classified by zone. As used herein, the zones are determined based on relative levels of activity, relative levels of interest, and levels of activity and/or interest that are trending up or down. In other words, the system uses this data to identify which zones have the lowest coverage among those that have relatively high levels of activity and interest and/or where the levels of activity and interest are trending upwards. In embodiments, identifying which zones have the lowest coverage is performed using a sum coverage by zone. In other words, classification module 1020 combines the services classified within the same zones to determine which zones show the most relative promise and which zones show the least relative promise. In such embodiments, the bottom zones may be outputted. In embodiments, bottom zones may comprise one of the bottom three zones, the bottom five zones, the bottom ten zones, or any other number of zones based on an entity's predetermined preference. As used herein, a bottom zone includes products that are popular, but for which there are few existing offerings.

In embodiments, new service module 1025 uses the labeled examples as examples for new services to generate potential service descriptions through a new service description generative AI request and generate new potential services. In embodiments, new service module 1025 may filter the potential service descriptions to existing services. In other words, if a newly generated service description is similar to an existing description, the two similar existing descriptions are paired, combined, coalesced, or marked as being similar. In embodiments, the potential service descriptions and potential services proceed to manual and/or automated review as described with respect to FIG. 9.

Accordingly, emerging market trends are extrapolated from industry data and from examples of trending services and summarized. This labeled data is used to train an SVM classifier that scores the alignment of services on offer with each market zone and selects emerging zones having the least coverage for candidate service generation.

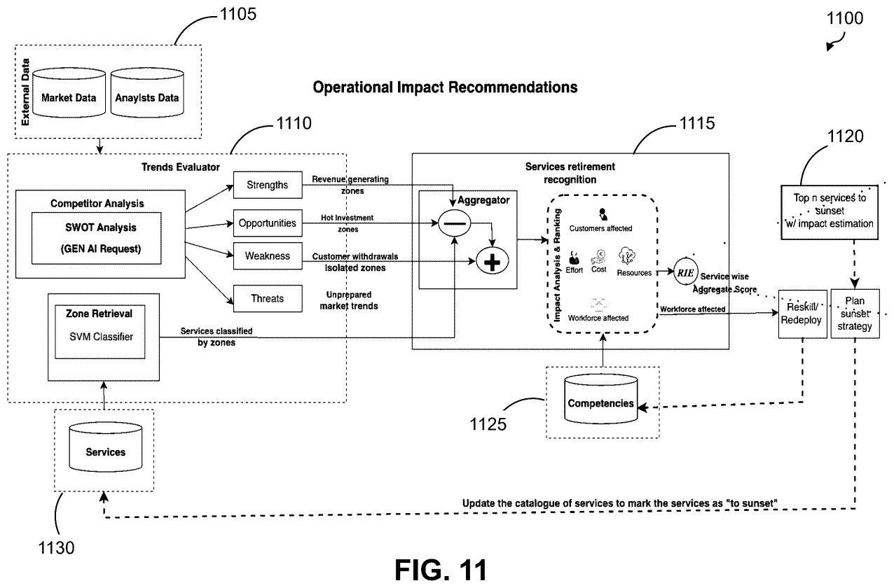

FIG. 11 shows an exemplary flow diagram 1100 in accordance with embodiments described herein. Specifically, FIG. 11 illustrates an exemplary method for determining which, if any, services should be sunset and/or removed in accordance with blocks 510 and 525 of FIG. 5. Flow diagram 1100 identifies services that no longer need to be part of the catalogue and can be sunset/removed. In embodiments, the system may further determine where employees who were concerned with maintaining the retired services may be utilized elsewhere, given their skills sets.

In embodiments, as explained above with respect to FIG. 5, operational impact module 415 of FIG. 4 may be configured to determine at least one service to sunset and/or remove from a list of services related to the entity based on the first data inputs. As used herein a service to remove is a service that is used infrequently, performs poorly, outdated, expensive, and/or any other reason an entity would no longer wish to use for some other business purpose including efficiency, budget, competency, and/or manpower. In embodiments, the determination to remove the service is further (or alternatively) made based on an RIE calculation. In such embodiments, the revenue impact efficiency is calculated by multiplying a revenue obtained from a service (R) with the sum of a workforce (W) affected by the service and the customers (C) affected, which is then multiplied by the effort (E) required to sunset the service. In other words, in such embodiments, the revenue impact efficiency=R×(W+C)×E.

In embodiments, the determination to remove the service is further (or alternatively) made based on one or more trend analyses. For example, the system (e.g., operational impact module 415 of FIG. 4) may evaluate external data 1105, which may include market data and analyst data, to determine market trends that may affect the entity. In embodiments, the trend analysis may include a strengths, weaknesses, opportunities, and threats (SWOT) analysis (e.g., like the SWOT analysis performed by service evolution ecosystem server 405, described above) that measures, or otherwise determines, the strengths, weaknesses, opportunities, and threats associated with the services related to the entity. As explained above, the strengths analysis may consider the revenue generating zones of the services, strong brand reputation, extensive expertise, and others. The weakness analysis may consider the number of competitors that have withdrawn from a specific service, limited consulting capabilities, and/or dependence on legacy infrastructure contracts. The opportunities analysis may consider areas where competitors are rapidly investing time, money, and/or resources into a specific service. The threats analysis may consider competitive pressures.

In embodiments, services retirement recognition 1115 aggregates the factors considered in the SWOT analysis and produces an RIE score to determine the top services 1120 to sunset with an impact estimation in accordance with block 525 of FIG. 5. The system may further provide suggestions about how a workforce might be rescaled or redeployed to different products based on the competencies 1125 of that workforce. Based on the findings, the catalogue of services 1130 may be updated to reflect the indicated changes (e.g., the services marked to be sunset).

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer system/server 12 (FIG. 1), can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, first data inputs related to an entity;
determining, by the processor set based on the first data inputs, at least one service to sunset from a list of services related to the entity;
generating, by the processor set based on the first data inputs, recommendations comprising ranked services to add to the list of services related to the entity;
determining, by the processor set based on the recommended ranked services, at least one new competency as a candidate for upgrading at the entity;
predicting, by the processor set, an overall impact to the entity based on at least one of sunsetting the at least one service, adding at least one service of the ranked services, and upgrading the at least one new competence at the entity;
notifying the entity of the prediction; and
performing at least one action based on the prediction.

2. The computer-implemented method of claim 1, wherein the at least one action comprises sunsetting the at least one service determined to be sunset from the list of services related to the entity.

3. The computer-implemented method of claim 1, wherein the at least one action comprises adding at least one new service of the new services to the list of services related to the entity.

4. The computer-implemented method of claim 1, wherein the first data inputs comprise: entity data, service provider data, competency data, and external data.

5. The computer-implemented method of claim 1, wherein the generating recommendations comprising ranked services based on the first data inputs comprises analyzing the first data inputs to determine strengths, weaknesses, opportunities, and threats associated with services related to the entity.

6. The computer-implemented method of claim 1, wherein the predicting the overall impact comprises predicting technology stack capabilities, technological resource requirements, personnel resource requirements, and cost, and
wherein the predicting the technology stack capabilities comprises measuring the technology stack by evaluating a technology stack performance and a technology stack scalability.

7. The computer-implemented method of claim 1, wherein the generating recommendations comprising ranked services to add to the list of services related to the entity is completed using prompts generated by a large language model (LLM).

8. The computer-implemented method of claim 1, further comprising recommending at least one upgrade to meet the determined at least one new competency.

9. The computer-implemented method of claim 1, further comprising receiving, based on the recommendations comprising ranked services to add to the list of services related to the entity, feedback data and second data inputs related to the entity.

10. A computer program product comprising one or more computer readable storage media having program instructions collectively stored on the one or more computer readable storage media, the program instructions executable to:
receive first data inputs related to an entity;
determine, based on the first data inputs, at least one service to sunset from a list of services related to the entity;
generate, based on the first data inputs, recommendations comprising ranked services to add to the list of services related to the entity;
determine, based on the recommended ranked services, at least one new competency as a candidate for upgrading at the entity;
predict an overall impact to the entity based on at least one of sunsetting the at least one service, adding at least one service of the ranked services, and upgrading the at least one new competence at the entity;
notify the entity of the prediction; and
perform at least one action based on the prediction.

11. The computer program product of claim 10, wherein the at least one action comprises sunsetting the at least one service determined to be sunset from a list of services related to the entity.

12. The computer program product of claim 10, wherein the at least one action comprises adding at least one new service of the new services to the list of services related to the entity.

13. The computer program product of claim 10, wherein the first data inputs comprise: entity data, service provider data, competency data, and external data.

14. The computer program product of claim 10, wherein the program instructions are further executable to recommend at least one upgrade to meet the determined at least one new competency.

15. The computer program product of claim 10, wherein the program instructions are further executable to receive feedback data and second data inputs related to the entity.

16. A system comprising:
a processor, a computer readable memory, one or more computer readable storage media, and program instructions collectively stored on the one or more computer readable storage media, the program instructions executable to:
receive first data inputs related to an entity;
determine, based on the first data inputs, at least one service to sunset from a list of services related to the entity;
generate, based on the first data inputs, recommendations comprising ranked services to add to the list of services related to the entity;
determine, based on the recommended ranked services, at least one new competency as a candidate for upgrading at the entity;
predict an overall impact to the entity based on at least one of sunsetting the at least one service, adding at least one service of the ranked services, and upgrading the at least one new competence at the entity;
notify the entity of the prediction; and
perform at least one action based on the prediction.

17. The system of claim 16, wherein the at least one action comprises sunsetting the at least one service determined to be sunset from a list of services related to the entity.

18. The system of claim 16, wherein the at least one action comprises adding at least one new service of the new services to the list of services related to the entity.

19. The system of claim 16, wherein the first data inputs comprise: entity data, service provider data, competency data, and external data.

20. The system of claim 16, wherein the program instructions are further executable to recommend the at least one action to upgrade at the entity to meet the determined at least one new competency.
